(19) United States
(12) Patent Application Publication
(10) Pub. No.: US 2004/0205246 A1
(43) Pub. Date: Oct. 14, 2004

(54) Method of identifying devices in wireless LAN home network environment

(75) Inventor: Soo-hong Park, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/746,234

(22) Filed: Dec. 29, 2003

(30) Foreign Application Priority Data
Dec. 30, 2002 (KR) 2002-87152

(51) Int. Cl. G06F 15/16

(52) U.S. Cl. 709/245; 370/310

(57) ABSTRACT

Provided are a method of identifying devices connected to wireless local area network (WLAN) home network and a recording medium on which a data structure having an address system that enables devices in a WLAN home network to be distinguished from one another is recorded. The method involves identifying the devices using device ID information recorded on part of an interface ID area other than a company ID area and a serial number area, the interface ID area having an EUI-64 ID format according to an IPv6 address system.

### BACKGROUND OF THE INVENTION

This application claims the priority of Korean Patent Application No. 2002-87152, filed on Dec. 30, 2002, in the Korean Intellectual Property Office, the disclosure of which is incorporated herein in its entirety by reference.

1. Field of the Invention

The present invention relates to a method of identifying devices connected to a network, and more particularly, to a method of identifying devices connected to wireless local area network (WLAN) home network and a computer-readable recording medium on which a data structure having an address system that enables devices in a WLAN home network to be distinguished from one another is recorded.

2. Description of the Related Art

The Internet environment has changed from a place where PCs and other PC-related devices are simply connected to the Internet to a place where all devices are not only connected to the Internet but also accessed by one another. Especially, due to the development of mobile telecommunication technologies, an increasing number of people want to enjoy Internet services when moving around.

Home appliances are not exceptions to the demands that the Internet environment has been facing. In other words, strenuous efforts have been made to enable a technique of allowing home appliances to share information with one another through networking while guaranteeing their specific functions. Consumers seem to want something more intelligent and more advanced than simple remote controllers so that they can easily control a variety of home appliances at any time in any place. Therefore, research has been vigorously carried out to come up with a better home network technique that enables home appliances, such as a TV set and a stereo, to be connected to one another and share information with one another. The current level of home network technology does not seem to pose any serious problems for people who attempt to access a plurality of home appliances in homes. However, more people want an improved Internet environment where they can freely access home appliances even from the outside of their homes and such home network devices can be easily connected to external Internet networks. For this to happen, a gateway-based technique where home networks can be connected to the Internet through gateways is necessary.

However, this gateway-based technique requires complicated protocol conversion processes, which may undesirably lead to overloaded or broken gateways and may eventually disturb and ruin communications among devices. In order to provide end-to-end services, which are among the most prominent characteristics of the Internet, communication devices are required to have their own addresses to communicate with each other. There is a need to communicate with a unique address that is used for providing end-to-end services. For this, devices to communicate with one another are required to have global addresses. However, given that many devices are generally provided in home, many addresses are necessary to make them communicate with one another having their own addresses.

Currently, 32-bit IPv4 addresses are used in various Internet environments. However, the problem of IP address shortages caused due to the exponential growth of the Internet and waste of IP addresses has long been waiting to be addressed. In this regard, such an IPv4 address system cannot fully support a variety of Internet environments, such as home networks where a considerable number of addresses are required.

In other words, the IPv4 address system can only provide at most 4.3 billion IP addresses. Therefore, it is nearly impossible to meet the demands of network environments, such as home networks, where innumerable addresses are necessary by simply using IPv4 technology. Network address translator (NAT)-based technology could be considered as an alternative to IPv4 technology. However, the NAT-based technology requires a technique of connecting devices inside a network to devices outside the network, which is inconvenient.

In order to access the Internet in homes, it is necessary to set a variety of variables, such as addresses. Most home network devices, unlike PCs, do not provide an environment where users can additionally allot addresses to them, and thus it is necessary to provide a function by which addresses can be automatically allotted to the home network devices. Dynamic host configuration protocol (DHCP) technology can dynamically allocate addresses to home network devices. However, since it requires management of a DHCP server, the DHCP technique may be considered inappropriate for home networks.

When it comes to home networks, security is one of the most important factors to be considered. Since an unauthorized person's access to a home network can cause many problems, it is very important to control any attempt to access the home network by authenticating every person who attempts to access the home network.

In this regard, IPv6 could be another plausible alternative to IPv4. IPv6 can provide a sufficient number of addresses to home network devices and can support automatic variable settings, such as automatic allocation of home device addresses to home devices, by realizing “plug-and-play” network access. In addition, IPv6 can provide IP Security Protocol (IPSEC) that protects and authenticates communication contents and communication participants.

FIG. 1 is a diagram illustrating the structure of an IPv6 address 100. In an IPv6 address 100, upper 64 bits, which constitute a network ID 110, are determined by a prefix allotted to each network. In general, in the case of generating global addresses, network equipment, i.e., a router, informs all users of the network ID so that the users can automatically set IPv6 addresses. More specifically, a 3-bit format prefix 111 indicates the type of address, a 13-bit TLA ID 112 is a prefix area for a most significant level, an 8-bit reserved area 113 is an area reserved for later use, a 24-bit NLA ID 114 is a prefix area for a next level, and a 16-bit SLA ID 115 is a prefix area for a site level.

Lower 64 bits constitute an interface ID 120, which is constituted by a 48-bit media access control (MAC) address of each device. The 64-bit interface ID 120 is generated for each device using an extended unique identifier (EUI)-64 format.

Therefore, the IPv6 address 100, which is made up of a total of 128 bits assigned to each device, is obtained by combining the 64-bit network ID 110 and the 64-bit interface ID 120 together.

Such advantages of IPv6 as abundant addresses, automatic setting functions, and security functions, make it possible for a variety of devices that have been considered so far as not being directly network-related to be connected to the Internet.

FIG. 2 is a diagram illustrating the structure of a MAC frame used in an IEEE 802.11 WLAN. Referring to FIG. 2, a MAC frame 200 includes frame control 210, a duration ID 220, address 1 (230), address 2 (240), address 3 (250), sequence control 260, address 4 (270), a frame body 280, and FCS 290. An address included in each frame follows rules of an MAC address system.

An MAC address is an address for identifying each host on a LAN, made up of 48 bits. The MAC address is comprised of a company ID 241, which is constituted by upper 24 bits, and serial number 242, which is constituted by lower 24 bits. The company ID 241 indicates a manufacturer of a corresponding device, assigned by the institute of Electrical and Electronics Engineers (IEEE). The serial number 242, comprised of lower 24 bits, indicates the serial number of the corresponding device. This 48-bit MAC address serves as an ID of the corresponding device.

As described above, an EUI-64 ID method is adopted to create an interface ID of an IPv6 address. The EUI-64 ID method can be used for automatic address configuration. When the EUI-64 ID method is used for automatic address configuration, it is necessary to set global bits of an interface ID. In the EUI-64 ID method, a 64-bit interface ID is generated by combining the 24-bit company ID 241 and the 24-bit serial number 242 of the above-mentioned 48-bit MAC address with a specific 16-bit value (0×FFFF).

FIG. 3 is a diagram illustrating an IPv6 address 300 including a 64-bit interface ID 120, which is generated according to the EUI-64 ID format. The 64-interface ID 120 includes a company ID area 241, a specific value area 310 where the specific value (0×FFFF) is recorded, and a serial number area 242 where a serial number is recorded.

An IPv6 address system adopting such an EUI-4 format takes advantage of MAC addresses, which are physical addresses of devices. However, a method of identifying the type of a device, which is suitable for the IPv6 address system, has not yet been suggested.

Korean Patent Publication No. 2002-47635 discloses an apparatus for setting an IP address of a home appliance, which is capable of more easily setting an IP address of a remote-controllable home appliance through remote-setting using a MAC address given to the home appliance at the time of manufacture. The apparatus for setting an IP address of a home appliance accumulates all MAC addresses of devices connected to its network, identifies home appliances to which IP addresses are yet to be allotted, and sets new IP addresses for the home appliances to which IP addresses are yet to be allotted by using their MAC addresses. This conventional technique, however, fails to suggest an IPv6-based method of setting an address for each home appliance.

### SUMMARY OF THE INVENTION

The present invention provides a method of identifying devices in a wireless local area network (WLAN) environment and a computer-readable recording medium on which a data structure having an address system that enables devices in a WLAN home network to be distinguished from one another is recorded.

According to an aspect of the present invention, there is provided a method of identifying devices in a wireless local area network (WLAN) home network environment. The method involves identifying the devices using device ID information recorded on part of an interface ID area other than a company ID area and a serial number area, the interface ID area having an EUI-64 ID format according to an IPv6 address system.

According to another aspect of the present invention, there is provided a method of identifying devices in a WLAN home network environment. The method involves identifying the devices using device ID information recorded on part of a company ID area of an interface ID area, which is not in use, other than a bit area provided for specific purposes, the interface ID area having an EUI-4 format according to an IPv6 address system.

According to still another preferred embodiment of the present invention, there is provided a computer-readable recording medium on which a data structure having an address system for identifying devices from one another in a WLAN home network, the data structure having an IPv6 address system comprising a network ID area for identifying a network where a device belongs and an interface ID area for identifying the address of the device in the identified network. Here, the interface ID area includes a company ID area for identifying the manufacturer of the device; a serial number area for identifying a serial number of the device; and a device ID area interpolated between the company ID area and the serial number area for identifying the type of the device.

According to yet still another preferred embodiment of the present invention, there is provided a computer-readable recording medium on which a data structure having an address system for identifying devices from one another in a WLAN home network, the data structure having an IPv6 address system comprising a network ID area for identifying a network where a device belongs and an interface ID area for identifying the address of the device in the identified network. The interface ID area includes a device ID area for identifying the type of the device; a company ID area for identifying the manufacturer of the device; and a serial number area for identifying a serial number of the device.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating the structure of a conventional IPv6 address;

FIG. 2 is a diagram illustrating the structure of a media access control (MAC) frame used in a conventional WLAN environment;

FIG. 3 is a diagram illustrating the structure of an IPv6 address adopting an EUI-64 ID format;

FIG. 4 is a diagram illustrating the structure of an IPv6 address used for identifying a device according to a first embodiment of the present invention;

FIG. 5 is a diagram illustrating various device IDs, which are set according to the method shown in FIG. 4;

FIG. 6 is a diagram illustrating various addresses of a DTV, which are set as device Ids;

FIG. 7 is a diagram illustrating a link local unicast address, a pseudo address, and a global unicast address of a refrigerator having the device ID 520 of FIG. 5 according to a first embodiment of the present invention;

FIG. 8 is a diagram illustrating a link local unicast address, a pseudo address, and a global unicast address of an air conditioner having the device ID 530 of FIG. 5 according to a first embodiment of the present invention;

FIG. 9 illustrates an IPv6 address 900 whose lower 64 bits constitute an interface ID according to an EUI-4 format;

FIG. 10 illustrates three device EUI-64 ID addresses created according to a first embodiment of the present invention;

FIG. 11 is a diagram illustrating a link unicast address, a pseudo address, and a global unicast address of a DTV according to a second embodiment of the present invention;

FIG. 12 is a diagram illustrating a link local unicast address, a pseudo address, and a global unicast address of a refrigerator according to a second embodiment of the present invention; and

FIG. 13 is a diagram illustrating a link local unicast address, a pseudo address, and a global unicast address of an air conditioner according to a second embodiment of the present invention.

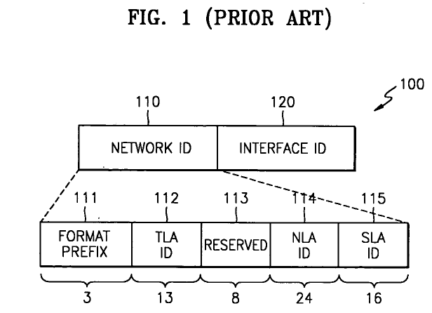

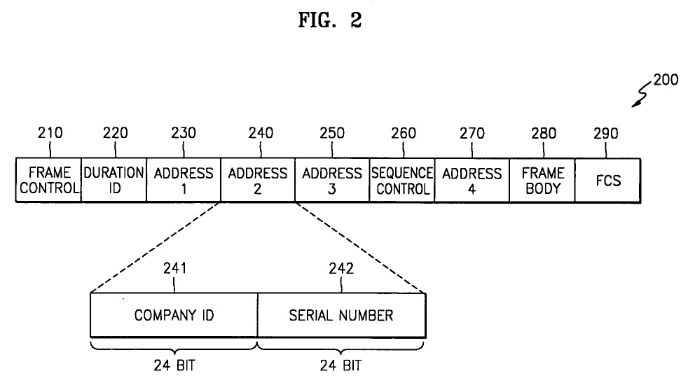

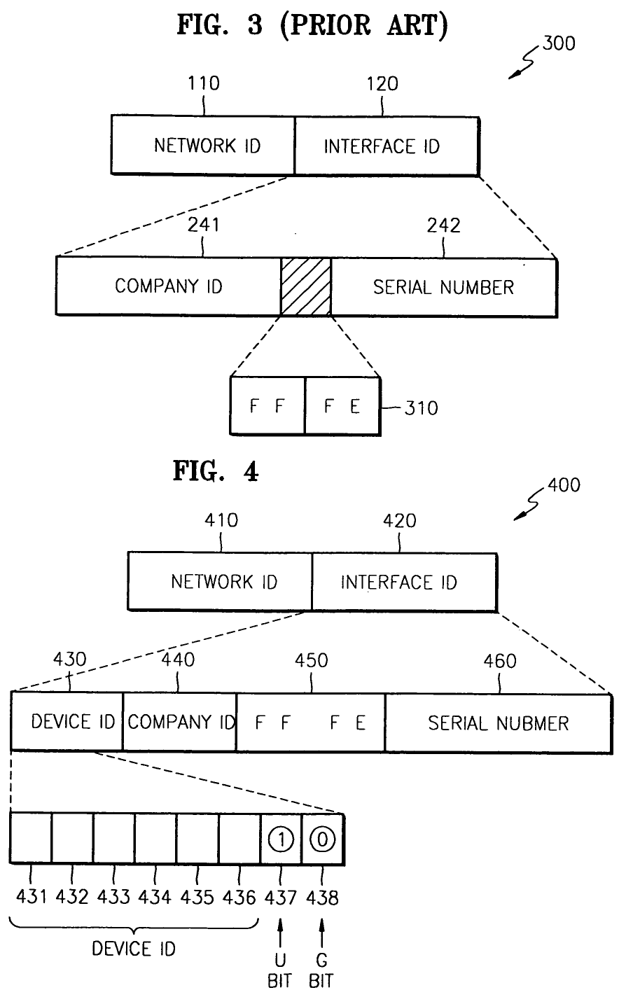

### DETAILED DESCRIPTION OF THE INVENTION

Hereinafter, the present invention will be described in greater detail with reference to the accompanying drawings in which exemplary embodiments of the present invention are shown.

In the following paragraphs, a method of identifying types of devices according to a first embodiment of the present invention will be described with reference to FIGS. 4 through 8.

FIG. 4 is a diagram illustrating an IPv6 address 400, including a 64-bit interface ID 420. The IPv6 address 400 is generated using a EUI-4 method.

The IPv6 address includes a network ID area 410 and an interface ID area 420. The interface ID area 420 includes a device ID area 430, a company ID area 440, a specific value area 450, and a serial number area 460.

The device ID area 430 accounts for part of the company ID area 440 assigned by the IEEE. An aspect of the present invention is that the type of device can be identified using part of the company ID area 440 that is not in use. In other words, the device ID area 430 can account for the company ID area 440 except for an area designated for indicating a company ID and an area designated for specific purposes. In the company ID area 440, for example, a U-bit area and a G-bit area could be provided as such areas for specific purposes.

In short, all devices can be allowed to have their own IDs by setting specific values for identifying the devices using part of the company ID area 440 that is not in use.

For example, as shown in FIG. 4, the device ID area 430 is generated using an upper one byte of the interface ID area 420. Among eight bits 431 through 438 of the upper one byte of the interface ID area 420, a seventh upper bit 437 is a U bit that is used for setting a universal bit, and an eighth upper bit 438 is a G bit that is used for setting an individual/group bit. Therefore, a desired value can be set as a device ID using the eight bits 431 through 438 of the upper one byte except for the seventh and eighth upper ones 437 and 438.

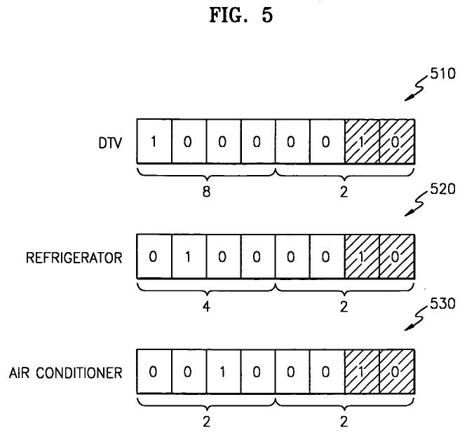

When devices connected to a predetermined home network have a plurality of identical device IDs, e.g., when a plurality of digital TVs are connected to a home network, they can be identified from one another by their serial numbers. Examples of such device IDs are illustrated in FIG. 5.

For example, in a most significant byte 510 of a device ID area for a digital TV, the uppermost bit can be set to ‘1’. Then, the upper four bits of the most significant byte 510 are “1000”, which corresponds to 8 in hexadecimal notation, and the lower four bits of the most significant byte 510 are “0010”, which corresponds to 2 in hexadecimal notation. Therefore, the most significant byte 510 is represented by “82”.

In a second byte 520 of a device ID area for a refrigerator, the uppermost bit can be set to ‘1’. Then, the upper four bits of the second byte 520 are “1000”, which corresponds to 4 in hexadecimal notation, and the lower four bits of the second byte 520 are “0010”, which corresponds to 2 in hexadecimal notation. Therefore, the second byte 520 is represented by “42”.

In a third byte 530 of a device ID area for an air conditioner, teh uppermost bit can be set to ‘1’. Then, the upper four bits of the third byte 530 are “0010”, which corresponds to 2 in hexadecimal notation, and the lower four bits of the third byte 530 happen to be “0010”, which corresponds to 2 in hexadecimal notation. Therefore, the third byte 530 is represented by “22”.

IPv6 addresses, unlike IPv4 addresses, are not allotted to devices in a one-on-one manner. Rather, a plurality of addresses could be allotted to a single device depending on what the device will be used for. Hereinafter, only unicast addresses among the addresses that can be allotted to a single device will be described in greater detail.

A link local unicast address cannot be used globally but can be used exclusively in a predetermined link. The link local unicast address starts with FE80 (hexadecimal notation). The link local unicast address can be automatically configured without specific settings. A pseudo address begins with “3FFF”, and a global unicast address, which is a global address used on the Internet, starts with ‘2001’ in hexadecimal nomination.

The link local unicast address can be configured without prefixes, and the pseudo address and the global unicast address can be configured only if a corresponding prefix information is obtained.

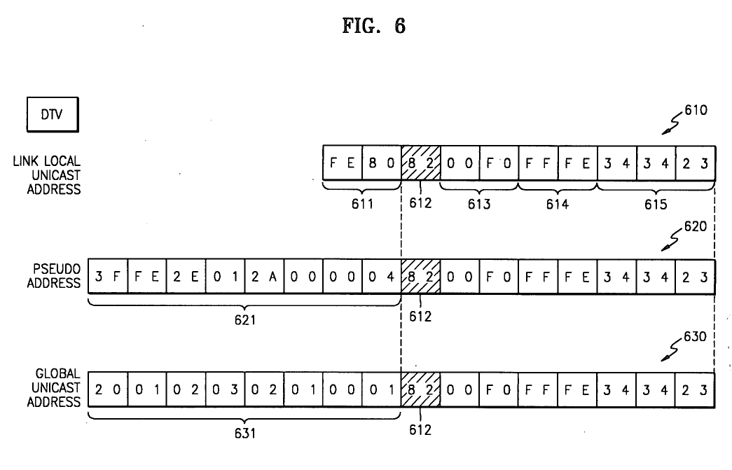

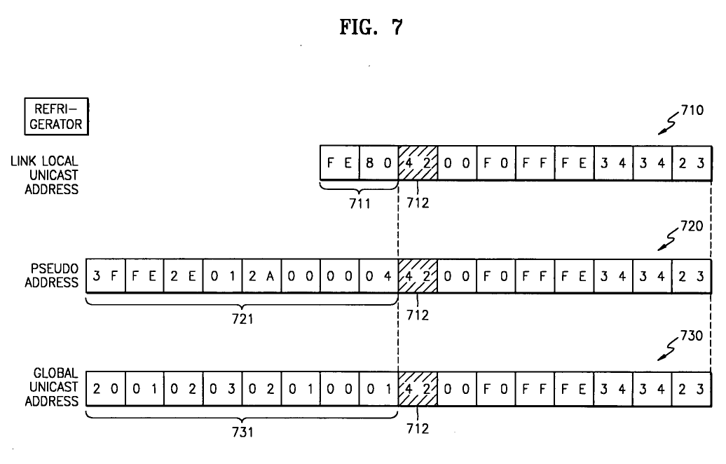

FIG. 6 is a diagram illustrating a link local unicast address, a pseudo address, and a global unicast address of a DTV having the device ID 510 of FIG. 5 according to a first embodiment of the present invention. Referring to FIG. 6, a link local unicast address 610 includes “FF80” (611) and an EUI-64 ID address comprised of a device ID area 612 set to “82”, a company ID area 613 set to “00F0”, a specific value area 614, and a serial number area 615 set to “343423”. Therefore, the link local unicast address 610 is represented by “FE80:8200:F0FF:FE34:3423”. A pseudo address 620 includes “3FFE:2E01:2A00:0004” (621) and the EUI-64 ID address. Thus, the pseudo address 620 is represented by “3FFE:2E01:2A00:0004:8200:F0FF:FE34:3423”. A global unicast address 630 includes “2001:0203:0201:0001” (631) and the EUI-64 ID address. Thus, the global unicast address is represented by “2001:0203:0201:0001:8200:F0FF:FE34:3423”.

FIG. 7 is a diagram illustrating a link local unicast address, a pseudo address, and a global unicast address of a refrigerator having the device ID 520 of FIG. 5 according to a first embodiment of the present invention. Referring to FIG. 7, an EUI-64 ID address of a refrigerator can be represented by “FE80:4200:F0FF:FE34:3423” in hexadecimal notation. A link local unicast address 710 of the refrigerator is represented by “FE80:4200:F0FF:FE34:3423” comprised of “FE80” (711) and the EUI-64 ID address. A pseudo address 720 of the refrigerator is represented by “3FFE:2E01:2A00:0004:4200:F0FF:FE34:3423” comprised of “3FFE:2E01:2A00:0004” (721) and the EUI-64 ID address. A global unicast address of the refrigerator is represented by “2001:0203:0201:0001:4200:F0FF:FE34:3423” comprised of “2001:0203:0201:0001” (731) and the EUI-64 ID address.

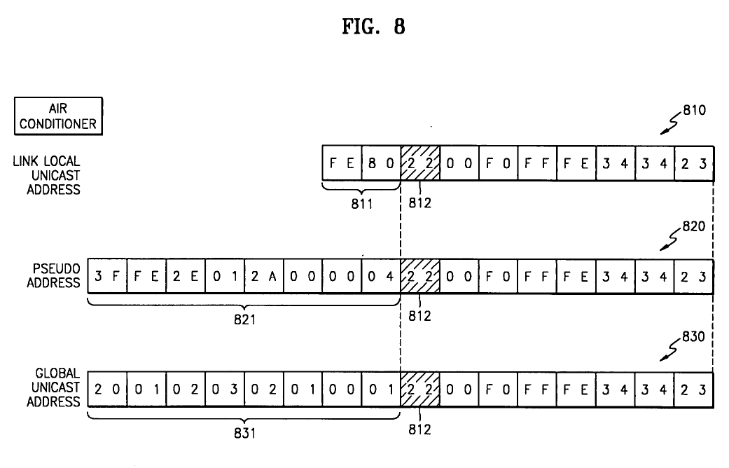

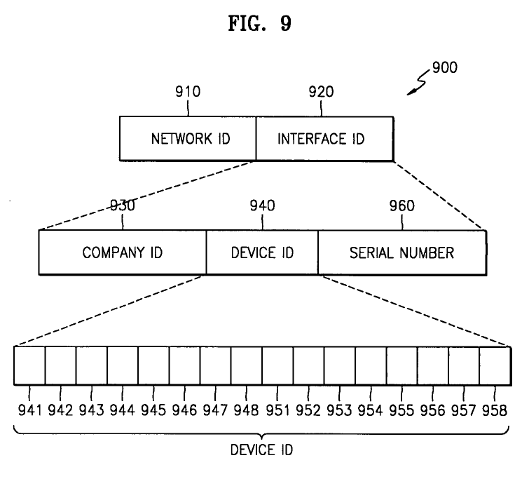

FIG. 8 is a diagram illustrating a link local unicast address, a pseudo address, and a global unicast address of an air conditioner having the device ID 530 of FIG. 5 according to a first embodiment of the present invention. Referring to FIG. 8, an EUI-64 ID address of an air conditioner can be represented by “2200:F0FF:FE34:3423” in hexadecimal notation. A link local unicast address 810 of the air conditioner is represented by “FE80:2200:F0FF:FE34:3423” comprised of “FE80” 811 and the EUI-64 ID address. A pseudo address 820 is represented by “3FFE:2E01:2A00:0004:2200:F0FF:FE34:3423” comprised of “3FFE:2E01:2A00:0004” (821) and the EUI-64 ID address. A global unicast address 830 of the refrigerator is represented by “2001:0203:0201:0001:2200:F0FF:FE34:3423” comprised of “2001:0203:0201:0001” (831) and the EUI-64 ID address, respectively.

Hereinafter, a method of identifying devices according to a second embodiment of the present invention will be described in greater detail with reference to FIGS. 9 through 13.

FIG. 9 illustrates an IPv6 address 900 whose lower 64 bits constitute an interface ID according to an EUI-4 format. As described above, the IPv6 address 900 includes a network ID area 910 and an interface ID area 920, and the interface ID 920 includes a company ID area 930, a device ID area 940, and a serial number area 960.

In the device ID area 940, a specific value “FFFE” which has been allotted from the IEEE is recorded. The basic concept of the present invention is to identify types of devices using such a specific value area as the device ID area 940. The specific value area, i.e., the device ID area 940, is comprised of 2 bytes, i.e., 16 bits ranging from 941 to 948 and ranging from 951 to 958. The device ID area 940 can take advantage of all or some of the sixteen bits. In other words, a device ID can be set using sixteen bits down from a most significant bit of the device ID area 940.

Accordingly, devices can be distinguished from one another by device IDs set using a specific area of an interface ID area of each IPv6 address without the need of additionally giving them names or setting variables differently.

In the meantime, if a plurality of devices connected to a single home network have the same device ID, for example, if a plurality of TVs are connected to a single home network, they can be distinguished from one another by their respective serial numbers.

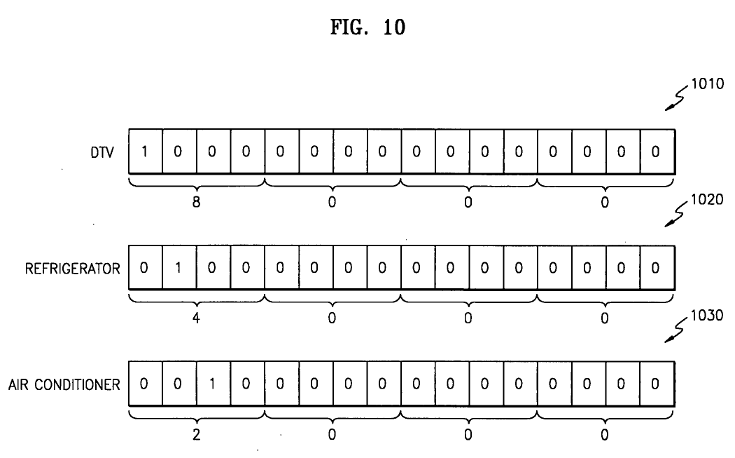

A device EUI-64 ID address created in the above-described method is illustrated in FIG. 10.

Referring to FIG. 10, a DTV may have a device ID address 1010 whose most significant bit is set to 1. Then, as shown in FIG. 10, upper four bits of the device ID address 1010 are “1000”, which corresponds to 8 in hexadecimal notation. Therefore, the device ID address 1010 can be represented by “8000” in hexadecimal notation.

A refrigerator may have a device ID address 1020 whose second bit is set to ‘1’. Then, as shown in FIG. 10, upper four bits of the device ID address 1020 are “0100”, which corresponds to 4 in hexadecimal notation. Therefore, the device ID address 1020 can be represented by “4000” in hexadecimal notation.

An air conditioner may have a device ID address 1030 whose third bit is set to 1. Then, as shown in FIG. 10, upper four bits of the device ID address 1030 are “0010”, which corresponds to 2 in hexadecimal notation. Therefore, the device ID address 1030 can be represented by “2000” in hexadecimal notation.

IPv6 addresses, unlike IPv4 addresses, are not allotted to devices on a one-on-one basis. Rather, a plurality of addresses can be allotted to each device depending on what they are used for. Of those addresses, a double unicast address will be described here in the following paragraphs.

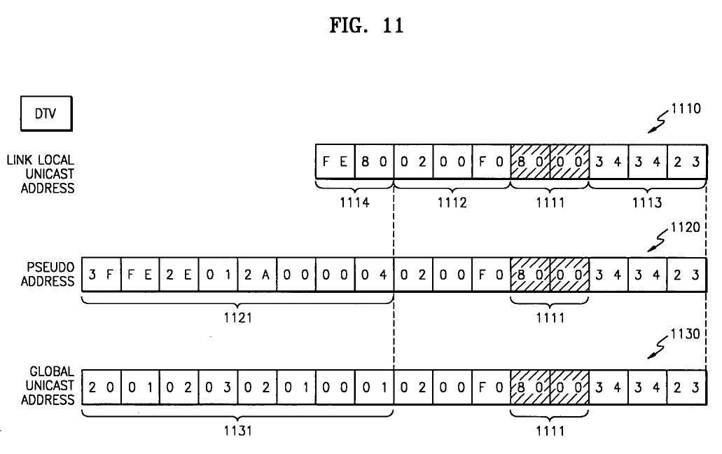

FIG. 11 is a diagram illustrating a link unicast address, a pseudo address, a global unicast address of a DTV according to a second embodiment of the present invention. Referring to FIG. 11, an EUI-64 ID address of a DTV can be represented by “0200”F080:0034:3423” in hexadecimal notation, comprised of a company ID area 1112 set to “0200F0”, a device ID area 1111 set to “8000”, and a serial number area 1113 set to “343423”. A link local unicast address 1111 of the DTV is represented by “0200:F080:0034:3423” comprised of “FE80” (1114) and the EUI-64 ID address. A pseudo address 1120 of the DTV is represented by “3FFE:2E01:2A00:0004:0200:F080:0034:3423” comprised of “3FFE:2E01:2A00:0004” (1121) and the EUI-64 ID address. A global unicast address 1130 is represented by “2001:0203:0201:0001:0200:F080:0034:3423” comprised of“2001:0203:0201:0001” (1131) and the EUI-64 ID address.

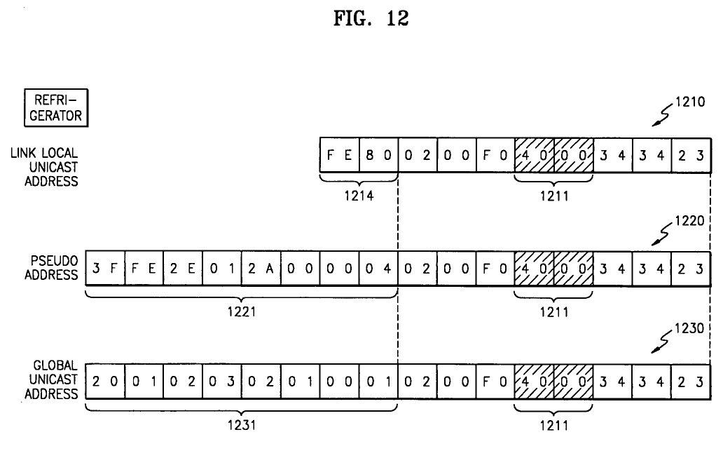

FIG. 12 is a diagram illustrating a link local unicast address, a pseudo address, and a global unicast address of a refrigerator according to a second embodiment of the present invention. As shown in FIG. 12, an EUI-64 ID address for a refrigerator is represented by “0200:F040:0034:3423”. A link local unicast address 1210 of the refrigerator is represented by “FE80:0200:F040:0034:3423” comprised of “FE80” (1214) and the EUI-64 ID address. A pseudo address 1220 of the refrigerator is represented by “3FFE:2E01:2A0:0004:0200:F040:0034:3423” comprised of “3FFE:2E01:2A00:0004” (1221) and the EUI-64 ID address. A global unicast address 1230 is represented by “2001:0203:0201:0001:0200:F040:0034:3423” comprised of“2001:0203:0201:0001” (1231) and the EUI-64 ID address.

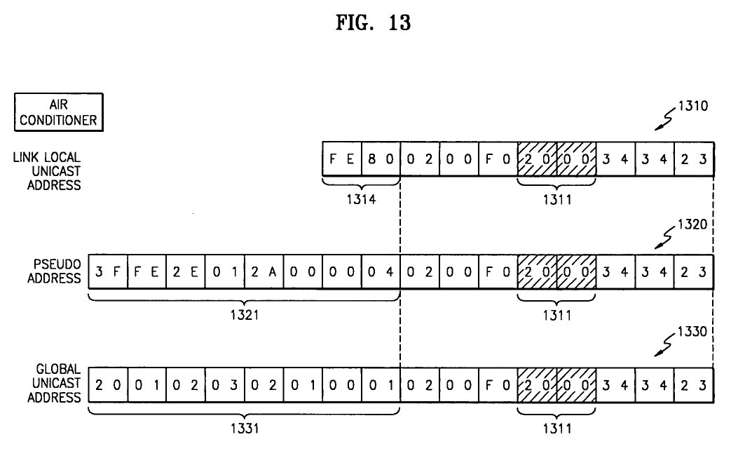

FIG. 13 is a diagram illustrating a link local unicast address, a pseudo address, and a global unicast address of an air conditioner according to a second embodiment of the present invention. Referring to FIG. 13, an EUI-64 ID address for an air conditioner is represented by “0200:F020:0034:3423” in hexadecimal notation. A link local unicast address 1310 of the air conditioner is represented by “FE80:0200:0034:3423” comprised of “FE80” (1314) and the EUI-64 ID address. A pseudo address 1320 of the air conditioner is represented by “3FFE:2E01:2A00:0004:0200:F020:0034:3423” comprised of “3FFE:2E01:2A00:0004” (1321) and the EUI-64 ID address. A global unicast address 1330 of the air conditioner is represented by “2001:0203:0201:0001:0200:F020:0034:3423” comprised of “2001:0203:0201:0001” (1331) and the EUI-64 ID address.

As described above, devices connected to a home network can have their own addresses due to a unique ID value set for each of them. In addition, by using global prefix information of the home network, it is possible to allot a link local unicast address and a global unicast address to each of the devices in the home network. Moreover, a link local unicast address can be additionally allotted to each of the devices in the home network. However, since the link local unicast address of each of the devices can only be used inside the home network, the global unicast address of each of the devices is necessary in a case where there is a need to connect the devices in the home network to devices outside the home network.

In a WLAN home network environment constituted by devices having device IDs set according to the present invention, a user can access the devices having an address system according to the present invention using his/her mobile phone by obtaining their home network addresses, i.e., the addresses that they have inside a home network, through multicasting. All-node multicast addresses (FF01::1) or (FF02::1) currently provided by IPv6 are expected to be serviced sooner or later.

More specifically, a mobile phone issues a request for the addresses of all devices connected to a home network through all-node multicasting. Then, all the devices respond to the request issued by the mobile phone by sending their respective address containing a device ID set according to the present invention to the mobile phone.

Thereafter, the cell phone identifies any desired device using the addresses of the devices in the home network. The cell phone mentioned here supposedly has a function that identifies types of devices based on device ID information of each of the devices. Even when there are a plurality of devices having the same device ID, the cell phone can distinguish the devices from one another by arranging their addresses in a predetermined order in consideration of 24 lower bits of their respective interface ID.

The IPv6 address system of the present invention can be realized as data recorded on a computer-readable recording medium. The computer-readable recording medium includes nearly all kinds of recording devices on which data can be recorded in a manner that enables a computer system to read the data. For example, the computer-readable recording medium could be a magnetic tape, such as ROM, RAM, or CD-ROM, a floppy disk, optical data storage, or a carrier wave, such as data transmission through the Internet. In addition, the computer-readable recording medium can be distributed to a plurality of computer systems connected to each other via a network, in which case the present invention can be realized as computer codes stored on the computer-readable recording medium in a decentralized manner.

As described above, according to the present invention, it is possible to identify types of devices on a WLAN home network using IPv6 addresses without additionally allotting addresses to those devices.

What is claimed is:

1. A method of identifying devices in a wireless local area network (WLAN) home network environment, the method comprising:
identifying the devices using device ID information recorded on part of an interface ID area other than a company ID area and a serial number area, the interface ID area having an EUI-64 ID format according to an IPv6 address system.

2. The method of claim 1 further comprising identifying the devices using the device ID information and a serial number allotted to each of the devices and recorded in the serial number area of the interface ID area.

3. A method of identifying devices in a WLAN home network environment, the method comprising:
identifying the devices using device ID information recorded on part of a company ID area of an interface ID area, which is not in use, other than a bit area provided for specific purposes, the interface ID area having an EUI-64 format according to an IPv6 address system.

4. The method of claim 3 further comprising identifying the devices using the device ID information and a serial number allotted to each of the devices and recorded in the serial number area of the interface ID area.

5. The method of claim 3, wherein the bit area comprises a U-bit area and a G-bit area.

6. A computer-readable recording medium on which a data structure having an address system for identifying devices from one another in a WLAN home network, the data structure having an IPv6 address system comprising a network ID area for identifying a network to which a device belongs and an interface ID area for identifying the address of the device in the identified network,
wherein the interface ID area comprises:
a company ID area for identifying the manufacturer of the device;
a serial number area for identifying a serial number of the device; and
a device ID area interposed between the company ID area and the serial number area for identifying the type of the device.

7. The computer-readable recording medium of claim 6, wherein the device ID area is located in a fourth or fifth upper byte of the interface ID area.

8. A computer-readable recording medium on which a data structure having an address system for identifying devices from one another in a WLAN home network, the data structure having an IPv6 address system comprising a network ID area for identifying a network to which a device belongs and an interface ID area for identifying the address of the device in the identified network,
wherein the interface ID area comprises:
a device ID area for identifying the type of the device;
a company ID area for identifying the manufacturer of the device; and
a serial number area for identifying a serial number of the device.

9. The computer-readable recording medium of claim 8, wherein the device ID area is part of the company ID area which is not in use.
